(19) United States
(12) Patent Application Publication
(10) Pub. No.: US 2023/0339063 A1
(43) Pub. Date: Oct. 26, 2023

(54) Heated Sander Device

(71) Applicant: Deborah Caporale, Gustine, CA (US)

(72) Inventor: Deborah Caporale, Gustine, CA (US)

(21) Appl. No.: 18/173,836

(22) Filed: Feb. 24, 2023

Related U.S. Application Data
(60) Provisional application No. 63/333,180, filed on Apr. 21, 2022.

(51) Int. Cl. B24B 23/02; B24B 23/00; B23Q 11/00

(52) U.S. Cl. CPC B24B 23/02; B24B 23/005; B23Q 11/0046

(57) ABSTRACT

The present invention relates generally to the field of sanders. More specifically, the present invention relates to a heated sander device comprised of a housing with at least one button, at least one battery, at least one motor, at least one heating element. The heating element may be located internally or externally and produces heat or heated air. The device is also comprised of a bottom surface that contains at least one continuous opening and a fastening system that allows a sanding disc to be attached to the bottom surface. The sanding disc has at least one continuous opening that aligns with the continuous opening of the bottom surface to allow heated air to flow from the internals of the device, through the continuous opening in the bottom surface, and through the continuous opening in the sanding disc to then heat the surface being sanded.

### CROSS-REFERENCE TO RELATED APPLICATION

The present application claims priority to, and the benefit of, U.S. Provisional Application No. 63/333,180, which was filed on Apr. 21, 2022, and is incorporated herein by reference in its entirety.

### FIELD OF THE INVENTION

The present invention relates generally to the field of handheld sanding devices. More specifically, the present invention relates to a handheld heated sander device comprised of a body or housing having a bottom surface, one or more controls or buttons, a power source, a motor, a blower, a heating element, a vacuum and a sanding disc. The heating element may be located internally or externally of the housing and is used to heat a flow of air, and the blower is used to expel the heated air onto a workpiece as its being sanded. The bottom surface is comprised of at least one continuous opening and a fastening system that allows the sanding disc to be removably attached to the bottom surface. The sanding disc is also comprised of at least one continuous opening that aligns with the continuous opening of the bottom surface to allow a waste created by the sanding operation to be vacuumed into a waste bag attached to the heated sander device. Accordingly, the present disclosure makes specific reference thereto. Nonetheless, it is to be appreciated that aspects of the present invention are also equally applicable to other like applications, devices and methods of manufacture.

### BACKGROUND

Sanders are commonly used amongst carpenters and laymen to accomplish a multitude of tasks. However, time is ultimately wasted when sanding surfaces because traditional sanding devices lack the ability to produce heat, which prevents the device from reaching particles deep in a wood grain. This in turn forces a user to sand excessively in order to reach the deeper particles, which may cause a user to spend copious amounts of time and energy sanding the workpiece, which is both inefficient and tim consuming. Further, paint strippers, sanders, and heat guns are all different devices that a user must purchase separately to accomplish relatively similar tasks if they wish to apply heat while sanding.

Therefore, there exists a long-felt need in the art for an improved sander device. There also exists a long-felt need in the art for a heated sander device that allows the user to access the deeper grains in a wood workpiece in a more efficient manner. Further, there exists a long-felt need in the art for a heated sander device that eliminates the need to have a paint stripper, sander, and a heat gun used separately to accomplished the same desired heated sanding effect. Moreover, there is a long-felt need in the art for a heated sander device that enables a user to simultaneously heat, blow and sand a workpiece, and then clean up the waste in an efficient and timely manner.

The subject matter disclosed and claimed herein, in one embodiment thereof, comprises a heated sander device. The device is primarily comprised of a housing, a bottom surface, one or more controls, a power source in the form of an electrical cord or one or more batteries, a motor, a blower, a vacuum, at least one heating element and a sanding disc. The heating element is powered by the power source and can be controlled by the one or more controls, such that heated air is produced from the device internally or externally in differing embodiments and applied to the workpiece in an efficient manner. The bottom surface comprises at least one continuous opening in fluid communication with the blower and/or the vacuum source and a fastening system that allows a sanding disc to be removably attached to the bottom surface. Likewise, the sanding disc also comprises at least one continuous opening that aligns with the continuous opening of the bottom surface to allow heated air or waste to flow therethrough.

In this manner, the heated sander device of the present invention accomplishes all of the forgoing objectives and provides an improved means to perform the task of sanding, paint stripping, heating, simultaneously. Further, the heated sander device uses a flow of heated air to help loosen deep areas in the wood to achieve a more efficient sanding operation.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The device is primarily comprised of a housing, at least one button or control, a power source in the form comprising battery or a power cord, a motor, a blower, a vacuum, a heating element, and a sanding disc. In different embodiments, the housing may be any ergonomic shape that easily accommodates a user's hand and allows the user to use the device with a single hand thereby freeing up the user's other hand for other tasks, such as holding the workpiece. The housing may be textured to allow a user to maintain a firm grip on the device during use. In one embodiment, the device housing may be comprised of non-slip grips that further provide the user with effective ways to maintain control of the device. The device is further comprised of a button positioned on the housing. In a differing embodiment, the button may be in the form of a switch or other suitable control. In one embodiment, the button can be used to turn the device on/off and may also allow a user to change differing levels of heated air flow from the device as well as different sanding speed levels or intensities. In another embodiment, the device may be comprised of a plurality of buttons that are used for operating a multitude of different functions such as turn the device off/on, change the vibrational intensity, and change the flow of air.

In one embodiment, the device can receive power from a power cord. The power cord supplies power to the battery. In another embodiment, the device may be powered pneumatically via compressed air through a compressed air source such as an air compressor. The power source further supplies power to the motor located within the housing. The motor may have a plurality of speed. In one embodiment, the speed levels can further be controlled by one button. In another embodiment, there are a plurality of buttons that can either turn the motor on and off, as well as change the varying speeds of the motor. The battery also supplies power to a heating element. In one embodiment, the heating element is located within the housing.

The bottom surface of the device can be rotated 360-degrees to be able to sand in a multitude of positions. The bottom surface is further comprised of at least one continuous opening that functions to suck the wood chips or other debris that are created by the device. The bottom surface further has at least one fastener that allows at least one sanding disc to attach to the bottom surface.

The device is further comprised of a blower and a vacuum. The blower blows air over the heating element, and onto the surface, thus providing a flow of hot air. The device is further comprised of a vacuum. The vacuum sucks dust and other particles through the continuous openings and into the sawdust bag. This allows for minimal needed cleanup.

The sanding disc corresponds in shape to the shape of the bottom surface and has at least one fastener on its top surface that attaches to the fastener of the bottom surface to allow the sanding disc to removably attach to the bottom surface. The sanding disc is further comprised of at least one continuous opening that aligns with the continuous opening of the bottom surface of the device. In this manner, air and other small debris such as wood chips can be sucked up through the continuous openings and into the sawdust bag.

The sawdust bag is attached to the housing and is used to collect the sawdust that is a byproduct of the sanding operation. The bag allows the user to remove the bag and dispose of the excess sawdust that was collected during use. The sawdust bag is further in fluid communication with the continuous openings. The sawdust bag may attach to the housing via a threaded fastener or other conventional means of attachment in various embodiments.

The heating element is located both inside and outside of the housing. However, it should be appreciated that in various embodiments the heating element can be located only inside, only outside, or both outside and inside of the housing.

Accordingly, the heated sander device of the present invention is particularly advantageous as it allows a user to sand deeper areas of a wooded workpiece more efficiently without wasting valuable time sanding the same areas multiple times. Further, the device uses directed heated air to aid in the sanding process to more easily remove old stain, paint and varnish from a surface with minimal effort and in a shorter period of time. In this manner, the heated sander device overcomes the limitations of existing sanders known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a heated sander device of the present invention in accordance with the disclosed architecture with a partially exploded out sander disk;

FIG. 2 illustrates a perspective view of one potential embodiment of a heated sander device of the present invention in accordance with the disclosed architecture; and

FIG. 3 illustrates a perspective view of one potential embodiment of a heated sander device of the present invention being used to both heat and sand a surface in accordance with the disclosed architecture; and

FIG. 4 illustrates one potential method of using the heated sander device of the present invention to both heat and sand a surface in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a sander that uses heated air to allow the user to reach deeper grain in a piece wood, leading to more efficient sanding. Further, there also exists a long-felt need in the art for a device that eliminates the need to use a paint stripper, sander, and a heat gun separately to achieve a desired sanding results and process. There also exists a long-felt need in the art for a sander that uses heated air to sand more efficiently.

The present invention, in one exemplary embodiment, is comprised of a heated sander device. The device is primarily comprised of a housing, further comprised of a blower, a vacuum, a heating element, a saw dust bag, a motor, and a sanding disc. The device may further be comprised of at least one button positioned on the housing that operates the functions of the device. In the preferred embodiment, there are a multitude of buttons that control different functions such as turn the device off/on, change the differing levels of air flow, and differing levels of sanding/motor speed. The device further is powered by a power source such as at least one battery or power cord.

The device is further comprised of a blower. The blower generates a flow of air that passes over the heating element to generate the heated air to loosen the particles in the desired surface. The device is further comprised of a vacuum that sucks the dust and other particles into at least one continuous opening and into the sawdust bag. The device also is comprised of a sanding disk, further comprised of at least one continuous opening that aligns with the continuous openings in the bottom surface of the housing.

Accordingly, the heated sander device of the present invention is particularly advantageous as it allows its user to more efficiently sand deeper areas of wood without wasting valuable time sanding the same areas multiple times. Further, the device uses directed heated air to aid in the sanding process to more easily remove old stain, paint, and varnish from a surface with minimal effort and in a shorter period of time. In this manner, the heated sander device overcomes the limitations of existing sanders known in the art.

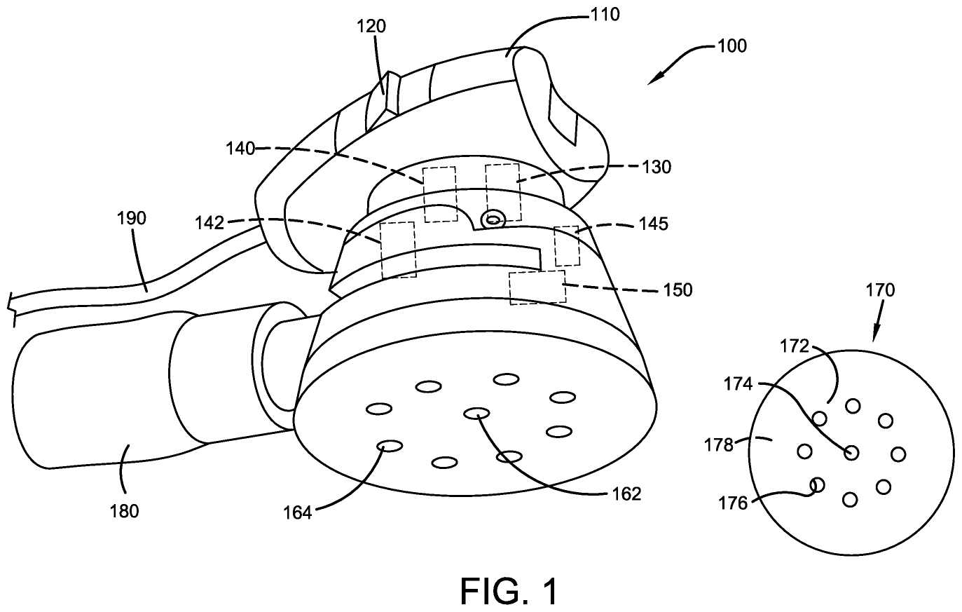

Referring initially to the drawings, FIG. 1 illustrates a perspective view of one potential embodiment of a heated sander device 100 of the present invention in accordance with the disclosed architecture. The device 100 is primarily comprised of a housing 110, at least one button or control 120, a power source in the form comprising battery 130 or a power cord 190, a motor 140, a blower 145, a vacuum 147, a heating element 150, and a sanding disc 170. In different embodiments, the housing 110 may be any ergonomic shape that easily accommodates a user's hand, and allows the user to use the device with a single hand thereby freeing up the user's other hand for other tasks, such as holding the workpiece. The housing 110 may be comprised of any suitable and durable material, such as a metal, rubber, plastic, etc., but is preferably made of a rigid plastic such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. The housing 110 may textured to allow a user to maintain a firm grip on the device during use. In one embodiment, the device housing 110 may be comprised of non-slip grips that further provide the user with effective ways to maintain control of the device 100. The device 100 is further comprised of a button 120 positioned on the housing 110. In a differing embodiment, the button 120 may be in the form of a switch or other suitable control. In one embodiment, the button 120 can be used to turn the device 100 on/off and may also allow a user to change differing levels of heated air flow from the device 100 as well as different sanding speed levels or intensities. In another embodiment, the device 100 may be comprised of a plurality of buttons 120 that are used for operating a multitude of different functions.

The device 100 can receive power from a power cord 190, which in one embodiment can be plugged into a standard 110/240V wall outlet. In one embodiment, the power cord 190 may supply power to the battery 130. In another embodiment, the battery 130 may be a disposable battery or a rechargeable battery in the form of an alkaline, nickel-cadmium, nickel-metal hydride battery, etc. such as any 3V-12-volt DC battery 130 or other conventional battery 130 such as A, AA, AAA, etc. that supply power to the device 100. Throughout this specification the terms “battery” and “batteries” may be used interchangeably to refer to one or more wet or dry cells or batteries 130 of cells in which chemical energy is converted into electricity and used as a source of DC power. References to recharging or replacing batteries 130 may refer to recharging or replacing individual cells, individual batteries 130 of cells, or a package of multiple battery cells as is appropriate for any given battery 130 technology that may be used. In another embodiment, the device 100 may be powered pneumatically via compressed air through a compressed air source such as an air compressor.

The power source further supplies power to the motor 140 located within the housing 110. The motor 140 may have a plurality of speed levels such as, but not limited to, low, medium and high, wherein the motor vibrates the device 100 more intensely at each level to achieve a more aggressive sanding effect. In one embodiment, the speed levels can further be controlled by one button 120. In another embodiment, there are a plurality of buttons 120 that can either turn the motor 140 on and off, as well as change the varying speeds of the motor 140.

The device 100 is further comprised of a blower 145 and a vacuum 147. The blower 145 blows air over the heating element 150, and onto the surface 200, thus providing a flow of hot air. The blower 145 may be any blower known in the art. The device 100 is further comprised of a vacuum 147. The vacuum 145 sucks dust and other particles through the continuous openings 174 and into the sawdust bag 180. This allows for minimal needed cleanup.

The battery 130 also supplies power to a heating element 150. In one embodiment, the heating element 150 is located within the housing 110 and may be any type of heating element 150 known in the art such as, but not limited, a heated coil, a heated fan, a heated compressor air blower, etc. The heating element 150 may further have a plurality of heating levels such as, but not limited to, low, medium, and high wherein each level produces a greater (volume) and/or hotter (temperature) amount of heat.

The bottom surface 160 of the device 100 can be rotated 360-degrees to be able to sand in a multitude of positions. In differing embodiments, the bottom surface 160 can be shaped such as but not limited to, circle, oval, square, triangle, rectangle, etc. The bottom surface 160 is further comprised of at least one continuous opening 164 that functions as to suck the wood chips or other debris that is created by the device 100. The bottom surface 160 further has at least one fastener 162 such as but not limited to: hook and loop, magnetic, adhesive, snap button, tongue and groove, clip etc. that allows at least one sanding disc 170 to attach to the bottom surface.

The sanding disc 170 corresponds in shape to the shape of the bottom surface 160 and has at least one fastener 174 such as, but not limited to, hook and loop, magnetic, adhesive, snap button, tongue and groove, clip, etc. on its top surface 172 that attaches to the fastener 162 of the bottom surface 160 to allow the sanding disc 170 to removably attach to the bottom surface 160. The sanding disc 170 is further comprised of at least one continuous opening 176 that aligns with the continuous opening 164 of the bottom surface 160 of the device 100. In this manner, air and other small debris such as wood chips can be sucked up through the continuous openings 176 and into the sawdust bag 180 In differing embodiments, the sanding disc 170 may have a plurality of grit levels such as, but not limited to, 40, 50, 60, 80, 100, 120, 150, 180, 220, etc.

The sawdust bag 180 is attached to the housing 110 and is used to collect the sawdust that is a byproduct of the sanding operation. The sawdust bag 180 is a removable bag that is preferably made from a fabric material. The bag 180 allows the user to remove the bag and dispose of the excess sawdust that was collected during use. The sawdust bag 180 is further in fluid communication with the continuous openings 176. The sawdust bag 180 may attach to the housing 110 via a threaded fastener or other conventional means of attachment in various embodiments.

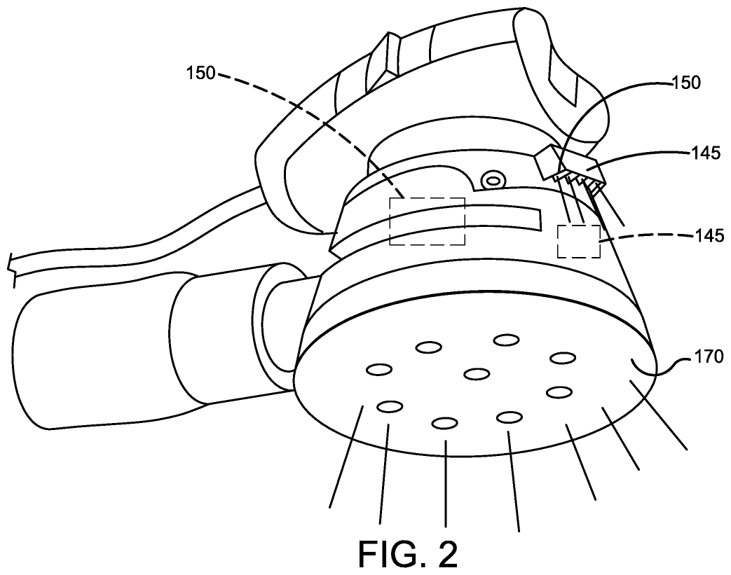

FIG. 2 illustrates a perspective view of one potential embodiment of a heated sander device 100 of the present invention in accordance with the disclosed architecture. In this embodiment of the device 100, a heating element 150 is located both inside and outside of the housing 110. However, it should be appreciated that in various embodiments the heating element 150 can be located only inside, only outside, or both outside and inside of the housing 110. Further, the blower 145 may also be located on the inside of outside of the housing. In one embodiment the blower 145 blows the hot air out of the side of the housing. In another embodiment the blower 145 blows hot air through the continuous openings 174 located on the sanding disc 170.

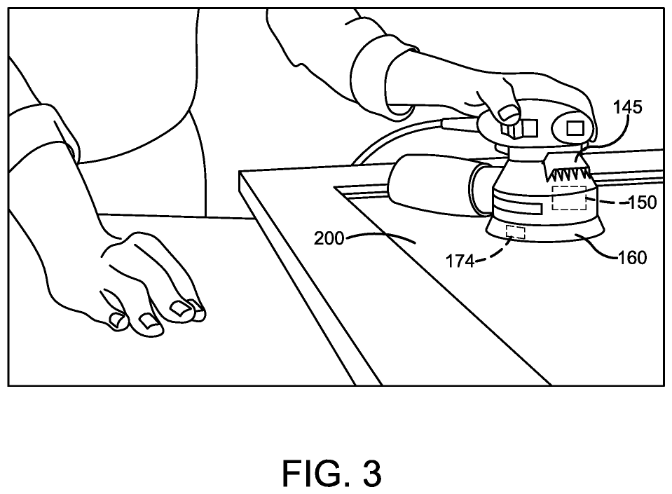

FIG. 3 illustrates a perspective view of one potential embodiment of a user using the heated sander device 100 of the present invention to both heat and sand a surface 200 in accordance with the disclosed architecture. The blower 145 on the device 100 pushes air over the heating element 150 which allows the surface to be hit with the hot air. This loosens the particles in the surface thus allowing for more convenient sanding. The device 100 also is comprised of a vacuum 147 that sucks the dust and other particles through the continuous openings 174 on the bottom surface 160 of the device 100. This prevents the user from having to spend copious amounts of time cleaning up the surface after using the device 100.

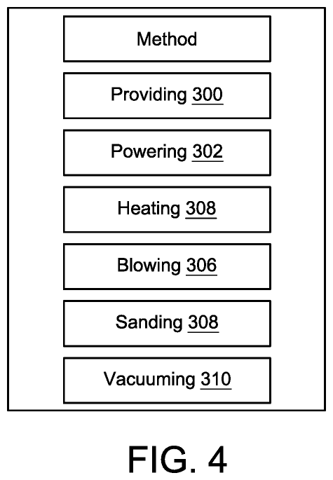

FIG. 4 illustrates one potential method of using the heated sander device 100 of the present invention to both heat and sand a surface in accordance with the disclosed architecture. The method begins by providing the heated sander device 100 of the present invention described above at Step 300, and powering the device 100 at Step 302. The device 100 may be powered by a traditional electrical wall outlet (not shown), or by one or more batteries 130. Regardless of the power source used, the electrical power not only powers the device 100 but it also heats the heating element 150 at Step 304. Then, at Step 306, the blower 145 is used to blow the heated air from the heating element 150 as the sanding device 100 is applied to the work surface 200 in an otherwise traditional manner to sand the same at Step 308. At Step 310, the waste generated by the sanding operation may be vacuumed by the vacuum 147 of the heated sander device 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “heated sander device” and “device” are interchangeable and refer to the heated sander device 100 of the present invention.

Notwithstanding the forgoing, the heated sander device 100 of the present invention and its various components can be of any suitable size and configuration as is known in the art without affecting the overall concept of the invention, provided that they accomplish the above-stated objectives. One of ordinary skill in the art will appreciate that the size, configuration and material of the heated sander device 100 as shown in the FIGS. are for illustrative purposes only, and that many other sizes and shapes of the heated sander device 100 are well within the scope of the present disclosure. Although the dimensions of the heated sander device 100 are important design parameters for user convenience, the heated sander device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A heated sander device comprising:
a housing;
a motor;
a heating element;
a bottom surface; and
a sanding disc.

2. The heated sander device of claim 1, wherein the sanding disc is removably attached to the bottom surface.

3. The heated sander device of claim 1 further comprising a blower for generating a flow of air.

4. The heated sander device of claim 3, wherein the flow of air passes over the heating element to generate a heated air.

5. The heated sander device of claim 4, wherein the heated air is expelled out of the housing in a direction of a workpiece.

6. A heated sander device comprising:
a housing;
a motor;
a heating element;
a blower;
a power source for powering the motor and the blower and heating the heating element;
a bottom surface having a continuous opening;
a sanding disc; and
at least one fastener for securing the sanding disc to the bottom surface.

7. The heated sander device of claim 6, wherein the blower generates a flow of air.

8. The heated sander device of claim 7, wherein the flow of air passes over the heating element to generate a heated air.

9. The heated sander device of claim 8, wherein the heated air is expelled out of the housing in a direction of a workpiece.

10. The heated sander device of claim 6, wherein the power source is an electrical cord.

11. The heated sander device of claim 6, wherein power source is a battery.

12. The heated sander device of claim 11, wherein the battery is a rechargeable battery.

13. The heated sander device of claim 6 further comprising a vacuum.

14. The heated sander device of claim 6, wherein the heating element comprises a plurality of heat settings.

15. The heated sander device of claim 14, wherein a select one of the plurality of heat settings may be chosen via a button located on the housing.

16. The heated sander device of claim 6, wherein the motor comprises a plurality of speeds.

17. The heated sander device of claim 16, wherein a select one of the plurality of speeds may be chosen via a button located on the housing.

18. The heated sander device of claim 11, wherein the at least one fastener is a hook and loop fastener, a magnetic fastener, an adhesive fastener, a snap button fastener, a tongue and groove fastener or a clip fastener.

19. The heated sander device of claim 6, wherein the sanding disc comprises a continuous opening that aligns with the continuous opening in the bottom surface.

20. A method of simultaneously heating, blowing and sanding a workpiece, the method comprising the steps of:
providing a heated sander device having a heating element, a blower and a vacuum;
powering the heated sander device;
heating the heating element;
blowing a quantity of air past the heating element and onto a workpiece as the same is being sanded by the heated sander device; and
vacuuming a waste created by the sanding of the workpiece with the heated sander device.
